(19) United States
(12) Patent Application Publication
(10) Pub. No.: US 2003/0051738 A1
(43) Pub. Date: Mar. 20, 2003

(54) Process for cleaning an integrated circuit package surface, for preparing the same for a subsequent ink marking process, and process for manufacturing an integrated circuit using such a cleaning process

(75) Inventors: Andrea Cigada, Brugherio (IT); Pierre Yves Shechter, Melaka (MY); Sivakumar Krithivasan, Singapore (SG)

Correspondence Address: SEED INTELLECTUAL PROPERTY LAW GROUP PLLC, 701 FIFTH AVE, SUITE 6300, SEATTLE, WA, 98104-7092, US

(73) Assignee: STMicroelectronics S.r.l., Agrate Brianza (IT)

(21) Appl. No.: 09/912,435

(22) Filed: Jul. 24, 2001

(30) Foreign Application Priority Data
Jul. 26, 2000 (IT) TO2000A 000739

(51) Int. Cl. B08B 7/04; B08B 7/00

(52) U.S. Cl. 134/1; 134/1.1; 134/1.3

(57) ABSTRACT

A process for cleaning an integrated circuit package surface, comprising the steps of introducing the integrated circuit inside a plasma chamber; and of exposing the integrated circuit to a physical plasma obtained starting from a gas consisting of pure argon or any other noble gas having, in the plasma state, the behavior of a halogen, for example helium. The argon pla sma is obtained using the following energization parameters: energization time, 12-13 seconds; energization power, 140-160 W; plasma chamber pressure, 190-210 millitorr; and energization frequency, between 1 kHz and 100 GHz.

### FIELD OF THE INVENTION

The present invention regards a process for cleaning of an integrated circuit package surface, for preparing the same for a subsequent ink marking process, and a process for manufacturing an integrated circuit using such a cleaning process.

### BACKGROUND OF THE INVENTION

As is known, the quality and persistence of the marks and data printed on integrated circuit package surfaces have always been considered an extremely important aspect in the semiconductor industry, for obvious reasons of identification, by the end customer, of the type of device, its characteristics, and the identity of the manufacturer.

One of the techniques most widely used in processes of marking of integrated circuit package surfaces is represented by the so-called ink marking, which is essentially an offset gravure printing and is obtained by transfer of ink, from the so-called printing form made on a special plate and inked by means of an inking roller, onto the integrated circuit package surface, using a rubber pad.

In order to render the quality and persistence of the data printed on integrated-circuit packages as good as possible, the marking process has always been preceded by a process of cleaning of the integrated circuit package surfaces with the purpose of removing impurities or residue deriving from previous processes which might cause what is printed on the integrated-circuit packages to become faded, incomplete, or even illegible, or which might cause fast degradation of the print over time.

In particular, among the numerous techniques for cleaning the integrated circuit package surfaces that are employed in cleaning processes, the main ones are essentially based either on the use of a hydrogen flame to burn away the impurities or the residue, or on the use of solvents, or else on the use of ozone produced starting from oxygen in an electrically charged environment.

For reasons of environment protection, as well as for technological reasons and reasons of flexibility of use, in the past a large number of integrated circuit manufacturers banned the ink-marking technique and the cleaning techniques described above from integrated circuit manufacturing processes.

In particular, ink marking was banned because, on the one hand, it requires the use of solvents, which are known to be environmentally harmful, and, on the other, because it involves the need to make different printing forms for markings containing different data, whilst the cleaning techniques described above were banned both to avoid the use of hydrogen, ozone and solvents, which are again known to be environmentally harmful, and because the cleaning technique using a hydrogen flame, in addition to being an intrinsically dangerous process, may damage, and in particular melt, the tin plating finishing of the integrated circuit and may oxidize the lead frame surface.

To overcome the drawbacks inherent in the ink marking technique described above, a so-called laser ink marking technique has been devised and introduced in the integrated circuit manufacturing processes, which basically envisages the application, on the integrated circuit package surface, of a thin film coated with a layer of dry ink, and heating of the film in the areas to be marked using a laser, thus causing transfer of the ink onto the integrated circuit package surface. This technique makes it possible to obtain transfer of ink onto the integrated circuit package without the use of solvents, thus in practice overcoming a large number of the drawbacks inherent in the traditional ink marking technique.

In order to overcome, instead, the drawbacks inherent in the techniques described above for cleaning the integrated circuit package surfaces, the U.S. Pat. No. 5,451,263 and U.S. Pat. No. 5,882,423 propose two different cleaning techniques involving the use of a plasma.

In particular, the U.S. Pat. No.5,451,263 describes a two step plasma cleaning technique, in which, in the first step, the integrated circuit is exposed to an oxygen and argon plasma atmosphere, substantially in equal parts, so as to remove carbon contaminants and ionic contaminants, whilst, in the second step, the integrated circuit is exposed to a hydrogen and ammonia plasma atmosphere, substantially in equal parts, so as to remove oxides and phosphates.

The U.S. Pat. No. 5,882,423, instead, proposes a two step plasma cleaning technique, in which, in the first step, the integrated circuit is exposed to a fluorinated plasma atmosphere, whilst, in the second step, the integrated circuit is exposed to an oxygen and argon plasma atmosphere, substantially in equal parts.

Both of the plasma cleaning techniques described above, however, present a number of drawbacks, the main one being the somewhat long overall duration of the cleaning processes of these techniques.

In particular, the duration of the processes adopting the plasma cleaning techniques described above is basically affected by the following three factors:

In the first place, the above techniques rely on the removal of impurities from the integrated circuit package surfaces should be performed using a chemical plasma, i.e., a plasma that carries out slow removal of the impurities by means of a chemical reaction with the impurities themselves, and the slowness of the chemical reactions involved in the cleaning process contributes considerably to lengthening the overall duration of the process itself.

In the second place, independently of the slow action of the chemical plasma, the aforesaid cleaning techniques entail the steps of energization of a first plasma atmosphere for carrying out the first cleaning step, de-energization of the first plasma atmosphere, removal of the plasma used in the first step, energization of a second plasma atmosphere for carrying out the second cleaning step, de-energization of the second plasma atmosphere, and finally removal of the plasma used in the second cleaning step, whereby the duration of each of the above steps considerably contributes to lengthening the overall duration of the cleaning process; and

In the third place, cleaning of the integrated circuit package surfaces performed by means of a chemical plasma can be carried out only through a so-called batch process, where the batches are rather large (typically, around 1200 integrated circuits divided into 20 frames containing 60 devices each), and the time required for introducing the batches into the plasma chamber and for taking them out considerably contributes to lengthening the cleaning process, which, in the example given above, is approximately 30 minutes.

In addition to this, the use of a chemical plasma also entails the availability of a sufficiently large chamber for containing the various batches, with consequent costs and occupation of space.

Finally, although the cleaning techniques described above have less serious environmental implications than do flame cleaning techniques, even so they are not altogether environmentally friendly, in that in any case they involve the use of gases such as argon, oxygen, ammonia, and hydrogen.

### SUMMARY OF THE INVENTION

According to principles of the present invention, a process for cleaning an integrated circuit package surface is provided.

According to the present invention, a process for cleaning an integrated circuit package surface is carried out using a physical plasma etch.

In one embodiment, a noble gas, such as argon is used. Ionization is carried by applying a continuous voltage, preferably between 100 and 200 watts. Alternatively, ionization is carried out by an RF voltage applied in the 1 kHz to 100 GHz range.

### DETAILED DESCRIPTION OF THE INVENTION

For a better understanding of the present invention, a preferred embodiment thereof is now described to provide a non-limiting example.

In particular, according to the present invention, cleaning of the integrated circuit package surface is carried out by a single-step process, in which the integrated circuit package is exposed to a physical plasma, namely, a plasma which, by using ion agitation, is able to remove a very thin layer of a few layers of atoms, from the integrated circuit package surface.

In detail of one embodiment, according to the cleaning process of the present invention, the integrated circuit is introduced inside a plasma chamber. Argon in the pure state is introduced into the plasma chamber. The argon plasma is energized using the following energization parameters: energization time: 12-15 seconds; energization power: b 140-160 W; and pressure of plasma chamber: 190-210 millitorr.

Ionization of the argon is obtained either by applying a high continuous voltage or by applying a radio-frequency voltage at a frequency of between 1 kHz and 100 GHz. A machine of a type used for standard vacuum deposition may be used, such machines and their method of use being well known in the art. A semiconductor processing machine known as a cluster tool, such as those made by Applied Materials, Varian, Hitachi, or other companies may be used following general techniques published and well known in the art with regard to plasma etching.

According to a variant of the cleaning process described above, any other noble gas which, in the plasma state, behaves like a halogen, in particular helium may be used instead of argon.

Comparative tests carried out by the applicant aimed at comparing the cleaning process according to the present invention and cleaning processes using hydrogen flame cleaning techniques, using solvents and using ozone, as described previously, have revealed the higher efficiency and the greater environmental compatibility of the cleaning process according to the present invention as compared to processes using cleaning techniques according to the known art.

In particular, the integrated circuit package surface that is obtained thanks to the removal therefrom of a very thin layer of just a few atoms in thickness is rougher than the original surface, and this is a decidedly advantageous effect for marking purposes, in that the surface roughness enables a quality and persistence of marking to be achieved that are decidedly superior to those obtainable using the cleaning techniques according to the prior art.

In addition, a higher quality and longer persistence of marking can be achieved both using the traditional ink marking technique described previously, and using any other marking technique, in particular the laser ink marking technique, with which excellent results are obtained.

In addition, cleaning of the integrated circuit package surfaces carried out using a physical plasma can be performed by means of an on-line process, which enables frame-by-frame cleaning, so altogether eliminating the aforementioned drawbacks linked to the use of a batch process. In fact, the present solution enables cleaning of one frame at a time, so that by adopting the process according to the invention a decidedly smaller plasma chamber is required than the one needed in a batch process, and the duration of the entire cleaning process, including the introduction and extraction of the frames, is from 30 to 50 times shorter than that required by a batch cleaning process.

With reference, for example, to the batch cleaning process mentioned previously, in which cleaning 20 frames containing 60 devices each involves approximately 30 minutes, with the on-line cleaning process, the same number of devices can be cleaned in a total time of 35-38 seconds, including the time for introduction and extraction of the frames into/from the plasma chamber.

Finally, it is clear that numerous modifications and variations may be made to the cleaning process described and illustrated herein, without thereby departing from the sphere of protection of the present invention, as defined in the attached claims.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A process for cleaning an integrated circuit package surface, comprising:
introducing said integrated circuit inside a plasma chamber; and
exposing said integrated circuit to a plasma said plasma being a physical plasma.

2. The cleaning process according to claim 1, wherein said physical plasma has a halogen-type behavior.

3. The cleaning process according to claim 1 wherein said physical plasma is obtained in the presence of a pure noble gas.

4. The cleaning process according to claim 3, wherein said noble gas is argon.

5. The cleaning process according to claim 1 wherein said step of exposing said integrated circuit to a physical plasma comprises the step of energizing said physical plasma by applying the following energization parameters: energization time, between 12 and 15 seconds; energization power, between 140 and 160 W; and plasma chamber pressure, between 190 and 210 millitorr.

6. The cleaning process according to claim 1, further including: applying a continuous voltage to obtain ionization of said plasma.

7. The cleaning process according to claim 1, further including:
applying a radio-frequency voltage at a frequency of between 1 kHz and 100 GHz, to obtain ionization of said plasma.

8. The cleaning process according to claim 1 wherein the exposing of said integrated circuit to a physical plasma occurs in a single exposure.

9. The process according to claim 1 wherein the package is composed of a ceramic material.

10. The manufacturing process according to claim 1, wherein said ink marking process is carried out using a laser ink marking technique.

11. The process according to claim 1 wherein the package is composed of a plastic material.

12. The process according to claim 1 wherein the package is composed of an epoxy resin material.

13. The process according to claim 1 wherein the package includes exposed metal components.

14. A process for manufacturing an integrated circuit, comprising:
cleaning of an integrated circuit package surface by introducing the packaged integrated circuit into a plasma chamber;
exposing the package surface to a physical plasma;
removing a layer of material from the package surface to clean the upper surface of the package; and
ink marking said package surface.

15. The manufacturing process according to claim 14, wherein said ink marking process is carried out using a laser ink marking technique.

16. The process according to claim 14 wherein the package is composed of a ceramic material.

17. The process according to claims 14 wherein the package is composed of a plastic material.

18. The process according to claim 14 wherein the package is composed of an epoxy resin material.

19. The process according to claim 14 wherein the package includes exposed metal components.
